(19) United States
(12) Patent Application Publication
(10) Pub. No.: US 2024/0259171 A1
(43) Pub. Date: Aug. 1, 2024

(54) TRANSMISSION CONFIGURATION INDICATIONS FOR DOWNLINK TRANSMISSIONS USING MULTIPLE TRANSMISSION AND RECEPTION POINTS

(71) Applicant: ZTE Corporation, Shenzhen (CN)

(72) Inventors: Bo GAO, Shenzhen (CN); Zhaohua LU, Shenzhen (CN); Ke YAO, Shenzhen (CN); Yang ZHANG, Shenzhen (CN); Ling YANG, Shenzhen (CN); Wenfeng LIU, Shenzhen (CN)

(21) Appl. No.: 18/521,330

(22) Filed: Nov. 28, 2023

Related U.S. Application Data
(63) Continuation of application No. PCT/CN2023/074159, filed on Feb. 1, 2023.

(51) Int. Cl. H04L 5/00; H04W 72/044; H04W 72/232

(52) U.S. Cl. CPC H04L 5/0094; H04W 72/046; H04W 72/232

(57) ABSTRACT

Methods, apparatus, and systems that relate to efficient indication of the beam states under the unified framework for downlink channels and reference signal transmissions in multiple transmission and reception points operations are disclosed. In one example aspect, a method for wireless communication includes determining one or more beam states associated with a transmission from a base station to a terminal device and performing the transmission according to the one or more beam states. One beam state is associated with multiple channels and reference signals.

### CROSS REFERENCE TO RELATED APPLICATIONS

This patent document is a continuation of and claims benefit of priority to International Patent Application No. PCT/CN2023/074159, filed on Feb. 1, 2023. The entire content of the before-mentioned patent application is incorporated by reference as part of the disclosure of this application.

### TECHNICAL FIELD

This patent document is directed to digital communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This patent document describes, among other things, techniques that related to efficient indication of the beam states under the unified framework for downlink channels and reference signal transmissions in multiple transmission and reception points operations.

In one example aspect, a method for wireless communication includes determining one or more beam states associated with a transmission from a base station to a terminal device and performing the transmission according to the one or more beam states. Multiple channels and reference signals are associated with a single beam state.

In another example aspect, a communication apparatus is disclosed. The apparatus includes a processor that is configured to implement an above-described method.

In yet another example aspect, a computer-program storage medium is disclosed. The computer-program storage medium includes code stored thereon. The code, when executed by a processor, causes the processor to implement a described method.

The disclosed techniques can be used to implement a precoding matrix that is suitable for both near field and far field communications, thereby allowing flexible switches between the different types of communications. In addition, the disclosed techniques provide example ways of determining certain parameters of the precoding matrix so as to reduce the signaling overhead for indicating the precoding matrix and to allow the precoding matrix to match a communication channel between two wireless communication nodes.

These, and other, aspects are described in the present document.

### BRIEF DESCRIPTION OF DRAWINGS

FIG. 1 illustrates an example beam-based transmission between one transmission and reception point (TRP) and one User Equipment (UE) panel.

FIG. 2 illustrates an example multi-TRP operation in accordance with one or more embodiments of the present technology.

FIG. 3 illustrates an example association between beam states and target channel/reference signal for multi-TRP operations under the unified transmission configuration indicator (TCI) framework in accordance with one or more embodiments of the present technology.

FIG. 4 illustrates a diagram for an example unified TCI framework for indicating downlink channels and reference signal transmissions in multi-TRP operations in accordance with one or more embodiments of the present technology.

FIG. 5 illustrates an example signaling framework in accordance with one or more embodiments of the present technology.

FIG. 6 is a flowchart representation of a method for digital communication in accordance with one or more embodiments of the present technology.

FIG. 7 shows an example of a wireless communication system where techniques in accordance with one or more embodiments of the present technology can be applied.

FIG. 8 is a block diagram representation of a portion of a radio station in accordance with one or more embodiments of the present technology can be applied.

### DETAILED DESCRIPTION

Section headings are used in the present document only to improve readability and do not limit scope of the disclosed embodiments and techniques in each section to only that section. Furthermore, some embodiments are described with reference to Third Generation Partnership Project (3GPP) Fifth Generation (5G) New Radio (NR) or Sixth Generation (6G) standard for ease of understanding and the described technology may be implemented in different wireless system that implement protocols other than the NR or 6G protocol.

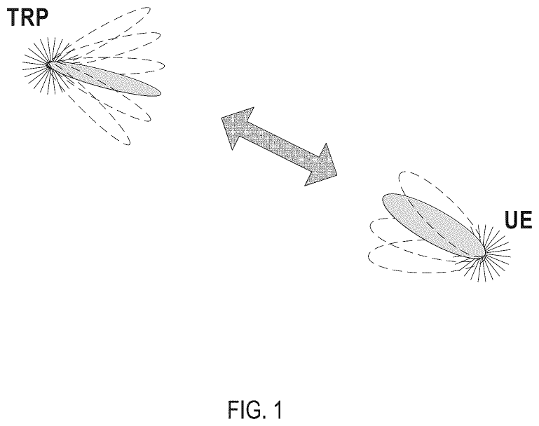

As the expense of wide or ultra-wide spectrum resources, the considerable propagation loss induced by the extremely high frequency becomes a noticeable challenge. To solve this, antenna array and beam-forming training technologies using massive Multiple-Input-Multiple-Output (MIMO) techniques, e.g., up to 1024 antenna elements for one node, have been adopted to achieve beam alignment and obtain sufficiently high antenna gain. To keep low implementation cost while still benefit from the antenna array, analog phase shifters become very attractive for implementing mmWave beam forming (BF), which means that the number of controllable phases is finite and the constant modulus constraints are placed on these antenna elements. Given the pre-specified beam patterns, the variable phase-shift-based BF training targets can identify the desired pattern for subsequent data transmission. FIG. 1 illustrates an example beam-based transmission between one transmission and reception point (TRP) and one User Equipment (UE) panel.

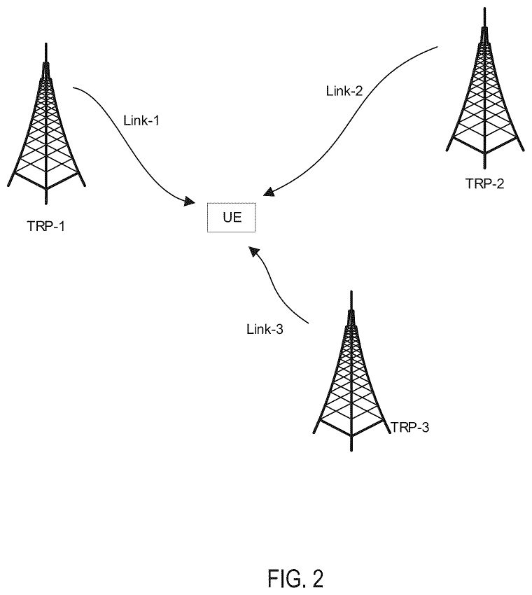

Multi-TRP operation has been considered as an emerging technique for balancing the deployment cost and throughput/robustness. FIG. 2 illustrates an example multi-TRP operation in accordance with one or more embodiments of the present technology. In multi-TRP operations, especially for Frequency Division Duplexing (FDD) or cell-edge UE in Time Division Duplexing (TDD), the Channel State Information (CSI) for determining downlink precoding, such as the Precoding Matrix Indicator (PMI), Rank Indicator (RI), Channel Quality Indicator (CQI), is reported from the UE to the base station. In some cases, even for a single transmission layer or a demodulation reference signal (DMRS) port, the precoding is provided for transmissions antennas across multi-TRPs accordingly.

In Long Term Evolution (LTE) systems, indication of the transmission configuration indicator (TCI) states has been flexibility adopted to indicate the mapping of the beam related information (e.g., between the reference signal, the Quasi-Co-Location (QCL) information, and/or the resources) to the transmission(s). However, the flexibility of the TCI state indication also brings significant signalling overhead. In 5G NR, a unified TCI framework has been adopted to the single TRP transmissions. The unified TCI framework associates a single TCI state (or a single beam state) with multiple channels and reference signals, including the Physical Downlink Control Channel (PDCCH), the Physical Downlink Shared Channel (PDSCH), the CSI Reference Signal (CSI-RS), the Physical Uplink Control Channel (PUCCH), the Physical Uplink Shared Channel (PUSCH) and/or the Sounding Reference Signal (SRS).

Extension of the unified TCI framework to multi-TRP operations, including non-coherent joint transmission (NCJT), coherent joint transmission (CJT) and single-frequency network (SFN), becomes urgent to enable efficient indication of the beam related information or beam states for mTRP operations. Several aspects need to be considered to enable the efficient indication of beam states for mTRP under the unified TCI framework:

(1) To facilitate dynamic switching between multi-TRP and single-TRP operations, a new field is needed to indicate a TCI/beam state for scheduling PDSCH using multi-TRPs. Instead of the conventional beam indication mechanism using the Radio Resource Control (RRC) signaling, the Medium Access Control (MAC) Control Element (CE) signaling, and a single Downlink Control Information (DCI) signaling, an additional field or signaling message is needed to identify the corresponding features when multiple TRPs are used for the transmission(s).

(2) To optimize CSI-RS resource usage and facilitate transmissions with certain scheduling offsets (e.g., a time-domain offset being smaller than a threshold), further considerations are needed for aperiodic CSI-RS in multi-TRP operations. The aperiodic CSI-RS transmissions can follow one of the indicated TCI states (respectively mapped to each TRP of multiple TRPs) as a default option, but a semi-static association or dynamic association can be considered.

(3) In order to support unified TCI framework for CJT and SFN, it is necessary to consider the mechanism of indicating the transmission mode and corresponding DMRS port(s) for facilitating the CJT/SFN transmission for PDSCH.

This patent document discloses techniques that can be implemented in various embodiments to enable efficient indication of the beam/TCI states under the unified TCI framework for downlink channels and reference signal transmissions in multi-TRP operations (e.g., PDCCH, PDSCH, and CSI-RS). The disclosed techniques can provide a multi-TRP beam state indication framework without introducing unnecessary signalling overhead and enable dynamic point selection for multi-TRP operations and dynamic switching between multi-TRP (mTRP) and single-TRP (sTRP) operations.

### Terminology

The term “beam state” generally encompasses the relevant information related to beam forming in the communication. A “beam state” can be interchangeable with a quasi-co-location (QCL) state, a transmission configuration indicator (TCI) state, a spatial relation (also referred to as spatial relation information), a reference signal (RS) in the downlink or uplink direction, a spatial filter, and/or a pre-coding matrix (or precoding information). Furthermore, the “beam state” is also referred to as “beam.” Furthermore, the TCI state comprises at least one of DL TCI state or joint TCI state for both DL and UL. Furthermore, a DL TCI state or joint TCI state for both DL and UL comprises one or more reference RS(s) and their corresponding QCL Type parameters.

Specifically, a “beam state” is associated with or comprises one or more reference RSs and/or their corresponding QCL type parameters, where QCL type parameters include at least one of the following aspect or combination: [1] Doppler spread, [2] Doppler shift, [3] delay spread, [4] average delay, [5] average gain, and [6] Spatial parameter. The definitions for ‘QCL-TypeA’, ‘QCL-TypeB’, ‘QCL-TypeC’, and ‘QCL-TypeD’ are as follows:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

The term “TCI state” is interchangeable with “beam state”.

The term “transmission (Tx) beam” can be interchangeable with a QCL state, a TCI state, a spatial relation state, a reference signal (e.g., CSI-RS, a synchronization signal block (SSB) that is also referred to as Synchronization Signal/Physical Broadcast Channel (SS/PBCH), a DMRS, an SRS, and/or a physical random access channel (PRACH)), a Tx spatial filter, or Tx precoding.

The term of “reception (Rx) beam” can be interchangeable with a QCL state, a TCI state, a spatial relation state, a Rx spatial filter, and/or Rx precoding.

The term of “beam identifier (ID)” can be interchangeable with a QCL state index, a TCI state index, a spatial relation state index, a reference signal index, a spatial filter index, or a precoding index.

The term “spatial relation information” includes one or more reference RSs that are used to represent the same or quasi-co spatial relation between a target RS/channel and one or more reference RSs.

The term “a spatial parameter” can be interchangeable with a spatial Tx parameter, a spatial Rx parameter, or a spatial filter. The spatial filter is also referred to as a spatial-domain filter. Specifically, the spatial filter can be either UE-side or gNB-side.

The term “channel” can be UL channel or DL channel.

The term “RS” can be UL RS or DL RS.

The term “UL channel” can be PUCCH or PUSCH.

The term “DL channel” can be PDCCH, or PDSCH.

The term “UL RS” can be SRS, PRACH, or DMRS for PUSCH and/or PUCCH.

The term “DL RS” can be SSB, CSI-RS, DMRS for PDSCH and/or PDCCH.

The term “UL signal” can be UL channel or UL RS (e.g., SRS, PRACH, DMRS, PUSCH or PUCCH).

The term “DL signal” can be DL channel or DL RS (SSB, CSI-RS, DMRS, PDSCH, or PDCCH).

The term “time unit” can be sub-symbol, symbol, slot, sub-frame, frame, or transmission occasion.

The term “first beam state” includes at least on of: a beam state with first location, beam state with a specific identifier.

The term “a specific identifier” includes at least one of: a lowest identifier, a highest identifier, an identifier equal to 0, or an identifier equal to 1.

The term “selected beam state(s)” can be interchangeable with effective beam state(s), a pool of beam state(s), or indicated beam state(s).

The term “DCI” is interchangeable with “PDCCH”.

The term “precoding information” includes at least one of: a Precoding Matrix Index (PMI), a Transmit Precoding Matrix Index (TPMI), a precoding, or a beam.

The term “TRP” is interchangeable with and can be represented by a RS port, a RS port group, RS resource, and/or a RS resource set.

The term “port group” is interchangeable with antenna group, or UE port group. The term “CSI report configuration” is interchangeable with CSI-AssociatedReportConfigInfo or CSI-ReportConfig. The term “a beam state is applied to a transmission” is interchangeable with “performing a transmission according to the beam state”.

### Unified Framework of Beam State Indication for Multi-TRP

Under the LTE framework, one or more beam states (e.g., TCI states) can be indicated by a command (e.g., DCI or a MAC-CE command) for determining a QCL assumption of a DL signal, or a spatial relation/power control parameters for a UL signal. Under the unified TCI framework, instead of indicating one beam state per channel/reference signal in the downlink or uplink direction, the indicated beam state can be applicable to multiple channels/RSs. For multi-TRP operations, it is necessary to bring in “an anchor” to connect the association between a beam state and each of channels/RSs. In this document, such an anchor is referred to as an association entry or an association parameter.

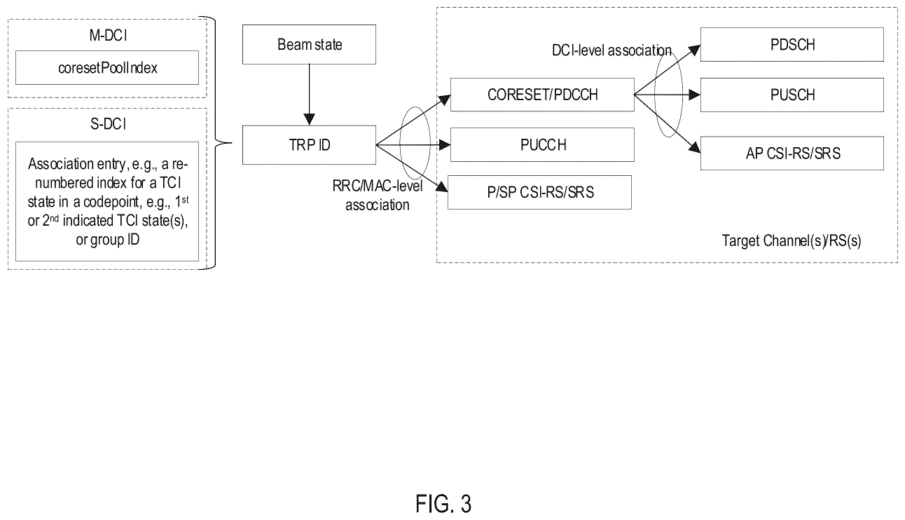

FIG. 3 illustrates an example association between beam states and target channel/reference signal for multi-TRP operations under the unified TCI framework in accordance with one or more embodiments of the present technology. The term “M-DCI” in FIG. 3 represents usage of multiple DCI signaling messages to schedule a mTRP transmission. The term “S-DCI” in FIG. 3 represents usage of a single DCI signaling message to schedule a mTRP transmission. A DCI signaling can be used as M-DCI or S-DCI without explicit distinctions in the DCI format(s) and/or fields. In the case of M-DCI, each DCI can be associated with a CORESET pool (e.g., via coresetPoolIndex) indicating the control resource set corresponding to the TRPs. The identifier of the CORESET pool (e.g., coresetPoolIndex) can thus function as the anchor (the association entry, the association parameter) to connect the beam state with the respective channel/reference signal.

In the case of S-DCI, a different or additional field can be used as the association entry to indicate the connection. At the MAC-CE level, when activating a plurality of TCI/beam codepoints, one or more beam state(s) can be activated for a beam codepoint and provided with a respective association entry. A beam/TCI codepoint includes a set of beam/TCI states, each having a respective index. The association entry can be a re-numbered index for a TCI state in a codepoint, e.g., 1^{st} beam state, 2^{nd} beam state, i-th beam state, 1^{st} beam state group, 2^{nd} beam state group, j-th beam state group. Herein, i and j denote an integer. Then one of the beam states can be indicated by a DCI message. Furthermore, the association parameter can include none (e.g., a null value). The ‘none’ (or the ‘null’ value) indicates that the channel/reference signal does not follow any one of the indicated beam/TCI states.

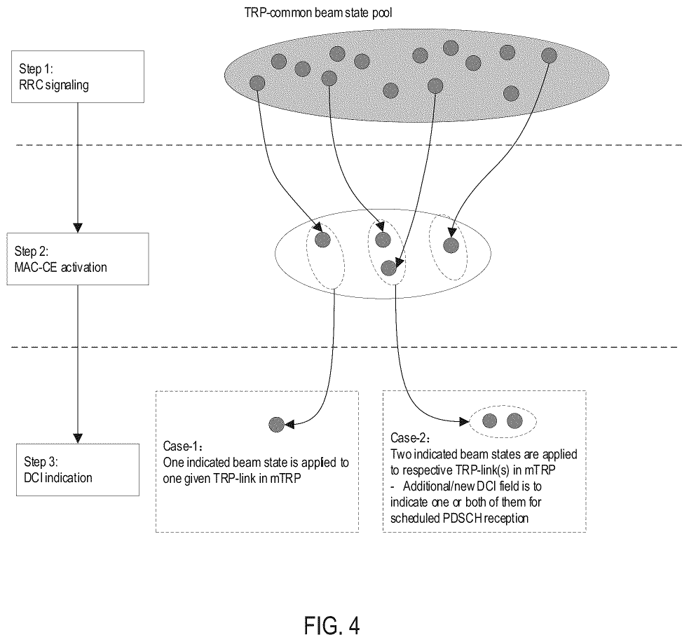

FIG. 4 illustrates a diagram for an example unified TCI framework for indicating downlink channels and reference signal transmissions in multi-TRP operations in accordance with one or more embodiments of the present technology. As shown in Case-1 of FIG. 4, DCI indication in step 3 can indicate a beam-state codepoint associated with a beam state. The association can be provided with an association entry (e.g., corresponding to the TRP or the first/second beam state). As shown in Case-2 of FIG. 4, DCI indication in step 3 can indicate a beam codepoint associated with two beam state(s). Each of them can be associated with a respective association entry corresponding to a TRP.

In some embodiments, a channel/RS can be configured with the association parameter such that the TCI/beam state(s) corresponding to the association parameter are apply to the channel/RS. For instance, candidate values for the association parameter comprises at least one of: none, 1^{st} beam state, 2^{nd} beam state, both 1^{st} and 2^{nd} beam states, a i-th beam state, all beam states in a codepoint, a 1^{st} beam state group, a 2^{nd} beam state group, both 1^{st} and 2^{nd} beam state groups, a j-th beam state group, all beam state groups in a codepoint. Herein, i and j denotes an integer.

For M-DCI based mTRP operations, the association entry can be included in the MAC-CE command to be associated with an activated beam state. The association entry can be the control resource set pool identifier (e.g., CORESETPoolId). The activated beam state is then applied to a channel/RS associated with the same association entry.

Beam Indication for PDSCH in S-DCI Based mTRP Operations

For S-DCI based mTRP operations, to accommodate channel changes (e.g., non-predicted link blockage), it is necessary to consider different transmission modes, such as dynamic switching between sTRP, NCJT, CJT and/or SFN mode. To support the dynamic switching, a new DCI filed can be provided to indicate which one or both of TCI states can apply to the scheduled PDSCH transmission.

To apply a beam state to a PDSCH, a plurality of beam state(s) (e.g., TCI states) can be configured in a first command (e.g., a RRC signaling message). A second command (e.g., MAC-CE command) can activate one or more beam codepoints (e.g., TCI codepoints). Each of beam/TCI codepoints comprises one or more beam state(s) from the plurality of beam state(s). A third command that includes a beam codepoint field (e.g., TCI codepoint indication field) indicates a codepoint from the one or more beam codepoints. The beam state(s) corresponding to the codepoint can be applied to the transmission (or considered as selected/effective beam state(s) for the transmission).

Finally, given a PDSCH transmission, a fourth command (e.g., a DCI message) that includes a beam state indication field (e.g., TCI state indication field) indicates one or more beam state(s) from the applicable/effective beam states. That is, the fourth command provides one or more association parameters by the beam state indication field. In some embodiments, for a given association entry/parameter, only one beam state is determined and applied. Furthermore, the beam state corresponding to the indicated codepoint is applied to the DL channel/RS associated with the same association entry as the beam state. In some embodiments, the applied beam state(s) are determined according to the time unit of PDSCH transmission. In some embodiments, the DCI comprises DCI format 1_1 and DCI format 1_2.

Furthermore, the condition that the beam state field indication field is present in the fourth command (e.g., a DCI message) comprises at least one of the following:
1. more than one beam states (e.g., DL or joint TCI state, or associated with a QCL type parameter) are associated with an activated beam codepoint;
2. an RRC parameter is provided to indicate that TCI state indication field is present in the DCI;
3. a control resource set (CORESET) corresponding to the fourth command comprises at least one of the following:
3a. a CORESET other than CORESET0 (a CORESET with index 0) is associated only with UE-Specific Search Space (USS) sets and/or Type3-PDCCH Common Search Space (CSS) sets;
3b. a CORESET is configured (e.g., by RRC) to follow the indicated TCI state(s) to PDCCH reception on the CORESET; or
3c. a CORESET is CORESET0 (a CORESET with index 0) or is associated with one or more CSS sets other than a Type3-PDCCH CSS set.

In some embodiments, the beam state indication field is absent in the fourth command, e.g., when at least one of the above conditions is not satisfied. Under such circumstances, the beam state(s) in the indicated codepoint are applied to the PDSCH transmission. Alternatively, or in addition, the beam state(s) that are effective/applicable to a transmission occasion of the PDSCH transmission are applied to the PDSCH transmission. The application of the beam state(s) can be performed regardless of a PDSCH scheduling offset (e.g., greater than, equal to, or less than a threshold).

Furthermore, the candidate values for a beam state indication field (e.g., TCI state indication field) comprises (1) a first value for a first beam state, (2) a second value for a second beam state, and (2) one or more values for both first and second beam states. The one or more values for “both first and second beam states” can include a third value corresponding to having both the first beam state and the second beam state for the transmission. The third value corresponding to having both the first beam state and the second beam state for the transmission further comprises at least one of: a value corresponding to having both the first and second beam state for a resource group of the transmission, a value corresponding to having the first beam state for a first resource group of the transmission followed by a second beam state for the second resource group of the transmission, or a value corresponding to having the second beam state for the first resource group of the transmission followed by the first beam state for the second resource group of the transmission.

In some embodiments, beam state indication field can indicate whether one or more effective TCI state(s) are applied to respective DMRS ports or all DMRS ports of a given PDSCH transmission.

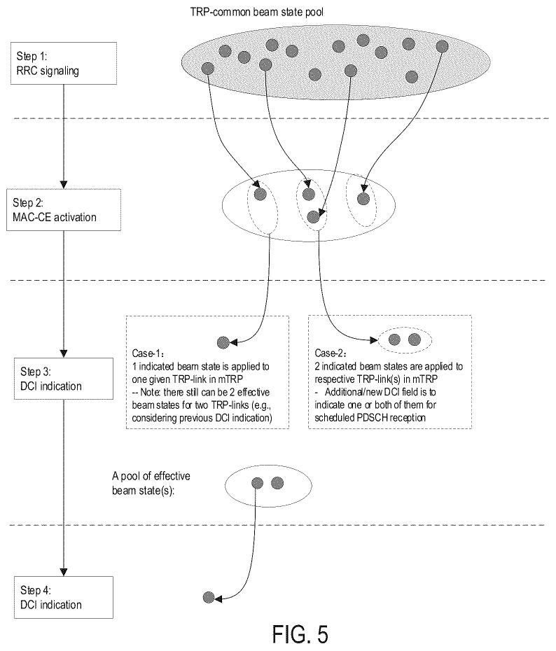

FIG. 5 illustrates an example signaling framework in accordance with one or more embodiments of the present technology. The example signaling framework shown in FIG. 4 includes RRC+MAC-CE+DCI (TCI codepoint indication field: down-selection for codepoint)+DCI format 1_1/2 (TCI state indication field for scheduling PDSCH). That, there is a four-level selection (TCI/beam state set->subset(combination)->one codepoint of subset->one or more TCI states from the codepoint) for indicating the beam state(s).

In some embodiments, the TCI state indication field is present in the DCI signaling when at least one of the following conditions are satisfied:
(1) decoupled with TCI_present_in_DCI. The presence of TCI state in the DCI may or may not be indicated by the field.
(2) more than one TCI states (e.g., DL or joint TCI states, or associated with a QCL type parameter) are associated with activated TCI codepoint; or
(3) an RRC signaling (e.g., a new RRC parameter) indicating whether TCI state indication field is present in the DCI or not.

If the TCI state indication field is absent, the TCI states in the indicated TCI codepoint are applied to PDSCH transmission scheduled by the DCI. Otherwise, the TCI states further indicated by the TCI state indication field are applied. In some embodiments, the TCI state(s) comprises the effective/indicated TCI states in the transmission occasion of the PDSCH. In some embodiments, the DCI comprises DCI format 1_1/2.

In some embodiments, the DCI signaling message that schedules the PDSCH transmission includes the TCI state indication field only, rather than both TCI codepoint indication field and TCI state indication field.

In some embodiments, candidate values of the TCI state indication field comprises ‘first’ indicating the first TPR, ‘second’ indicating the second TPR, ‘both’ indicating both the first and the second TPR. Here, ‘both’ can refer to at least one of ‘first-second’, ‘second-first’, ‘SFN’, ‘CJT’ or ‘NCJT’-TDM/FDM/SDM. The candidate values can be configured by RRC.

In some embodiments, the TCI state indication field or the RRC parameter of the RRC signaling can indicate whether the two TCI state(s) in an indicated codepoint are applied to respective DMRS ports or all DMRS ports associated with the PDSCH transmission.

In some embodiments, regarding the PDSCH with scheduling offset being less than a threshold, at least one of the following schemes is considered.

Scheme 1-1: The beam state indication field in the fourth command indicates one or more beam state(s) for the PDSCH transmission regardless of the value of the scheduling offset. This is due to the fact that, from UE's perspective, the beam-buffer (analog) is pre-determined before receiving the signaling. The pool of effective beam states (e.g., selected beam state(s)) indicated by the third command (e.g., the beam codepoint field in the DCI) can provide a clear indication of UE behavior regarding how to buffer beam in advance. Correspondingly, for a given PDSCH reception by the UE, the demodulation/decoding can be performed in the digital field and is not relevant to the threshold for the scheduling offset. In such cases, the UE can indicate, to the base station, its support for multiple default beams (e.g., ‘two default beams’) using UE capability signaling.

Scheme 1-2: A specific beam state is applied to the PDSCH. The specific beam state comprises at least one of following: (1) a first beam state, (2), a beam state indicated by a higher layer signaling message such as MAC-CE or RRC, (3) a beam state associated with a given time unit, or (4) a beam state associated with a CORESET with a specific identifier (e.g., the lowest ID). The CORESET can be associated with the same association entry/parameter as the PDSCH. In some embodiments, the CORESET is monitored (e.g., by the UE). In some embodiments, CORESET with the specific identifier is in the latest slot of the transmission. That is, the beam state is associated with the CORESET with lowest ID in the latest slot of the transmission.

Whether Scheme 1-1 or Scheme 1-2 is used is determined based on the UE capability and/or base station configurations by RRC or MAC-CE. In some embodiments, the above schemes are only applicable to UEs operating in the Frequency Range 2 (FR2). It is due to the fact that, in FR2, UEs need to use more than one analog beams established by more than one UE antenna panel simultaneously, and having more than one UE antenna panel is up to UE capability/implementation.

In some embodiments, the PDSCH is scheduled by DCI format 1_0, which does not include any TCI/beam state indication field. In those cases, at least one of the following is considered:

Scheme 2-1: The beam state applied to the CORESET or search space set for scheduling the PDSCH is applied to the PDSCH.

In some embodiments, only one beam state is applied in the CORESET, and the same beam state is applied to the PDSCH

In some embodiments, two or more beam state(s) are applied in the CORESET. Both or all of the two or more beam states can be applied to the PDSCH (Scheme 2-la). Alternatively, one specific beam state of the two or more beam states is applied (Scheme 2-1b). The one specific beam state comprises at least one of: (1) a first beam state of the two or more beam states, or (2) a beam state pre-determined per CORESET or the searching space set. Whether Scheme 2-1a or Scheme 2-1b is applied is based on the UE capability or configurable by RRC or MAC-CE. For energy saving concerns or UE capability limitations, having more than one effective beam states by default increases UE implementation complexity. Furthermore, as a condition, the CORESET can only be associated with one TCI state, scheduling offset of a PDSCH >=a threshold, or FR-1.

Scheme 2-2: A specific beam state is applied to the PDSCH. The specific beam state comprises at least one of following: (1) a first beam state, (2), a beam state indicated by a higher layer signaling message such as MAC-CE or RRC, (3) a beam state associated with a given time unit, or (4) a beam state associated with a CORESET with a specific identifier (e.g., the lowest ID). The CORESET can be associated with the same association entry/parameter as the PDSCH. In some embodiments, the CORESET is monitored (e.g., by the UE). In some embodiments, CORESET with the specific identifier is in the latest slot of the transmission. That is, the beam state is associated with the CORESET with lowest ID in the latest slot of the transmission.

In some embodiments, the beam codepoint is associated with the association entry/parameter. That is, given an association entry, only one beam codepoint is activated, and the beam states of the beam codepoint are applied. As an example, the following two cases can occur when only one beam codepoint is activated.
Case 1: RRC+MAC-CE+DCI format 1_0 (to schedule PDSCH).
Case 2: RRC+MAC-CE+DCI format 1_1/2 (to schedule PDSCH).

As another example, two beam codepoints are activated in the MAC-CE, each of which is associated with a different association entry/parameter. Then, the two beam codepoints are applied.

For dynamic switching between CJT/SFN and NCJT, the switching can be enabled by the beam state indication (e.g., the new field in DCI), indicating the beam state(s) corresponding to the transmission mode. If the UE does not support dynamic switching, the switching can also be enabled using semi-static configuration by RRC.

Beam Indication for CSI-RS in S-DCI Based mTRP

The CSI-RS has three time-domain behaviors: aperiodic, semi-persistent, and periodic.

For aperiodic CSI-RS (AP-CSI-RS), beam states applied to the AP-CSI-RS can be determined according to an indication field in DCI command (e.g., DCI format 0_0/1/2). The indication field comprises at least one of: the SRS resource set indicator and/or the beam state indication field. The beam state indication field can be introduced as a new field for DCI format 0_1/2.

For example, the TCI state(s) applied to AP-CSI-RS can be determined according to the SRS resource set indicator (e.g., to follow first or second TCI state), an additional association parameter, and/or a new TCI state indication field for AP-CSI-RS/PUSC. Furthermore, the association parameter for indicating which TCI state applied to the AP-CSI-RS is configured per CORESET/SS set. The association parameter(s) for AP-CSI-RS can also be configured per CSI-RS resource, CSI-RS resource set, CSI-RS setting, CSI-RS config, or CSI-RS triggering state.

When a triggering offset for the AP-CSI-RS is smaller than a threshold, the following schemes can be considered:

Scheme 3-1: The beam state applied to the AP-CSI-RS is still determined based on the indication field in DCI command or association parameter(s) for AP-CSI-RS, regardless of scheduling offset).

Scheme 3-2: A specific beam state is applied to the PDSCH. The specific beam state comprises at least one of following: (1) a first beam state, (2), a beam state indicated by a higher layer signaling message such as MAC-CE or RRC, (3) a beam state associated with a given time unit, or (4) a beam state associated with a CORESET with a specific identifier (e.g., the lowest ID). The CORESET can be associated with the same association entry/parameter as the PDSCH. In some embodiments, the CORESET is monitored (e.g., by the UE). In some embodiments, CORESET with the specific identifier is in the latest slot of the transmission. That is, the beam state is associated with the CORESET with lowest ID in the latest slot of the transmission.

Scheme 3-3: A beam/TCI state that is applied to a given CORESET is applied to the AP-CSI-RS. The given CORESET can be a latest monitored CORESET with lowest ID, or a first CORESET indicated by MAC-CE/RRC or having a time-unit pattern.

Whether Scheme 3-1, Scheme 3-2, or Scheme 3-3 is used is based on UE capability or configurable by RRC or MAC-CE. Furthermore, in a triggering state or config for the AP-CSI-RS, the setting/config can be additionally associated with an indication of a first, a second, or both beam/TCI states that can be applied to the AP-CSI-RS.

For semi-persistent CSI-RS (SP-CSI-RS) and periodic CSI-RS (P-CSI-RS), the following can be considered:
(1) Association parameter(s) for SP-CSI-RS/P-CSI-RS can be configured per CSI-RS resource/CSI-RS resource set/CSI-RS setting/config.
(2) Time-domain parameters (e.g., a time domain offset) can be provided simultaneously (e.g., in the TCI state).

When activating a SP-CSI-RS transmission, the association parameter(s) for SP-CSI-RS can be provided in MAC-CE. Furthermore, the time-domain parameters (e.g., the time domain offset) can be associated with beam state.

Beam Indication for PDSCH in M-DCI Based mTRP

For a PDSCH with a scheduling offset that is greater than or equal a threshold, there is sufficient time for the UE to determine that the PDSCH should follow the beam state associated with the same identifier (e.g., CORESETPoolId) as the scheduling PDCCH/DCI.

For a PDSCH with scheduling offset that is smaller than a threshold, one the other hand, the following schemes can be considered:

Scheme 4-1: beam state associated with the same CORESET pool of the CORESET is applied, regardless of scheduling offset;

Scheme 4-2: A specific beam state is applied to the PDSCH. The specific beam state comprises at least one of following: (1) a first beam state, (2), a beam state indicated by a higher layer signaling message such as MAC-CE or RRC, (3) a beam state associated with a given time unit, or (4) a beam state associated with a CORESET with a specific identifier (e.g., the lowest ID). The CORESET can be associated with the same association entry/parameter as the PDSCH. In some embodiments, the CORESET is monitored (e.g., by the UE). In some embodiments, CORESET with the specific identifier is in the latest slot of the transmission. That is, the beam state is associated with the CORESET with lowest ID in the latest slot of the transmission.

Whether Scheme 4-1 or Scheme 4-2 is used is based on UE capability or configurable by RRC or MAC-CE.

Beam Indication for CSI-RS in M-DCI Based mTRP

In some embodiments, the coresetPoolIndex can be the association entry/parameter. For P-CSI-RS/SP-CSI-RS, the coresetPoolIndex can be configured per CSI-RS resource, CSI-RS resource set, CSI-RS resource setting or report config. Then, beam state associated with the same coresetPoolIndex can apply to the CSI-RS. In some embodiments, time-domain parameters (e.g., a time domain offset) can be provided simultaneously. For example, the time-domain parameters can be associated with beam state (e.g., be provided by RRC).

For AP-CSI-RS, the following options can be considered:

Option-1: The coresetPoolIndex is determined according to the PDCCH/CORESET triggering the AP-CSI-RS, and then the beam state associated with the same coresetPoolIndex can be applied to the CSI-RS.

Option-2: The coresetPoolIndex can be configured per CSI-RS resource, CSI-RS resource set, CSI-RS resource setting, or CSI report config.

When the AP-CSI-RS triggering offset is smaller than a threshold, the following schemes can be considered:

Scheme 5-1: The beam state associated with the same CORESET pool of the CORESET is applied, regardless of scheduling offset.

Scheme 5-2: A specific beam state is applied to the PDSCH. The specific beam state comprises at least one of following: (1) a first beam state, (2), a beam state indicated by a higher layer signaling message such as MAC-CE or RRC, (3) a beam state associated with a given time unit, or (4) a beam state associated with a CORESET with a specific identifier (e.g., the lowest ID). The CORESET can be associated with the same association entry/parameter as the PDSCH. In some embodiments, the CORESET is monitored (e.g., by the UE). In some embodiments, CORESET with the specific identifier is in the latest slot of the transmission. That is, the beam state is associated with the CORESET with lowest ID in the latest slot of the transmission.

Whether Scheme 5-1 or Scheme 5-2 is used is based on UE capability or configurable by RRC or MAC-CE. Furthermore, in a triggering state or config, the CSI-RS setting/config can be additionally associated with the coresetPoolIndex.

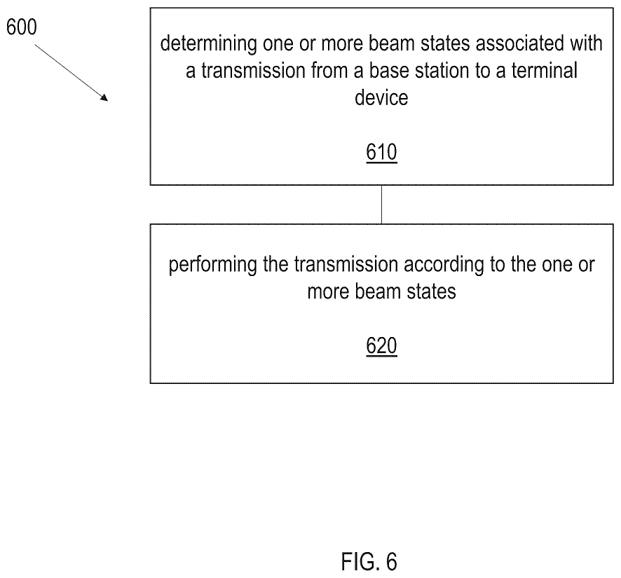

FIG. 6 is a flowchart representation of a method 600 for digital communication in accordance with one or more embodiments of the present technology. The method 600 includes, at operation 610, determining one or more beam states associated with a transmission from a base station to a terminal device. In method 600, multiple channels and reference signals are associated with a single beam state (e.g., using the unified TCI framework). The method 600 also includes, at operation 620, performing the transmission according to the one or more beam states. A beam state comprises at least one of a transmission configuration indicator (TCI) state, a quasi-co-location (QCL) state, a spatial relation, a reference signal (RS), a spatial filter, or a pre-coding matrix. A beam state can correspond to at least one of: a port associated with the transmission, a port group associated with the transmission, a reference signal resource associated with the transmission, or a reference signal resource set associated with the transmission. The transmission comprises at least one of a physical downlink control channel (PDCCH) transmission, a physical downlink shared channel (PDSCH) transmission, or a channel state information reference signal (CSI-RS) transmission.

In some embodiments, the method includes transmitting, by the base station to the terminal device, a first signaling message (e.g., RRC) configuring a plurality of beam states; transmitting, by the base station, a second signaling message (e.g., MAC CE) to the terminal device to activate one or more beam codepoints. Each of the one or more beam codepoints corresponds to at least one beam state of the plurality of beam states. The method includes transmitting, by the base station, a first Downlink Control Information (DCI) message to the terminal device. The first DCI message comprises a first field indicating a beam codepoint from the one or more beam codepoints activated by the second signaling message, where a pool of beam states or selected beam state(s) can be determined according to the beam codepoint. The method also includes transmitting, by the base station, a second DCI message to the terminal device scheduling the transmission. The one or more beam states are applied to the transmission, the one or more beam states being from the selected beam state(s) or a specific beam state.

In some embodiments, the method includes receiving, by the terminal device, a first signaling message (e.g., RRC) from the base station configuring a plurality of beam states; and receiving, by the terminal device from the base station, a second signaling message activating one or more beam codepoints (e.g., MAC CE). Each of the one or more beam codepoints corresponds to one or more beam states of the plurality of beam states. The method includes receiving, by the terminal, a first Downlink Control Information (DCI) message from the base station. The first DCI message comprises a first field indicating a beam codepoint from the one or more beam codepoints activated by the second signaling message. The method includes determining a pool of beam states or selected beam state(s) according to the beam codepoint and receiving, by the terminal device, a second DCI message from the base station scheduling the transmission. The one or more beam states are applied to the transmission, the one or more beam states being from the selected beam state(s) or a specific beam state.

In some embodiments, a second field is present in the second DCI message for indicating the one or more beam states. Candidate values of the second field comprise at least one of a first value corresponding to having a first beam state for the transmission, a second value corresponding to having a second beam state for the transmission, a third value corresponding to having both the first beam state and the second beam state for the transmission. In some embodiments, the third value corresponding to having both the first beam state and the second beam state for the transmission further comprises at least one of: a value corresponding to having both the first and second beam state for a resource group of the transmission, a value corresponding to having the first beam state for a first resource group of the transmission followed by a second beam state for the second resource group of the transmission, or a value corresponding to having the second beam state for the first resource group of the transmission followed by the first beam state for the second resource group of the transmission. In some embodiments, the resource group comprises at least one of a reference signal port, a reference signal port group, a reference signal resource, a reference signal resource set, a resource block (RB) group, or a transmission repetition. In some embodiments, the third value is associated with a non-coherent joint transmission mode, a coherent joint transmission mode, a single frequency network mode, a first mode in which the first and second beam states are applied to respective Demodulation Reference Signal (DMRS) port groups of the transmission, and/or a second mode in which the first and second beam states are applied to a DMRS port of the transmission.

In some embodiments, the second field is present in the second DCI signaling due to a condition being satisfied. The condition includes at least one of: (1) the pool of beam states or the selected beam state(s) include more than one beam states associated with a QCL type parameter; (2) one of the one or more beam codepoints corresponds to more than one beam state(s) associated with a QCL type parameter; (3) a presence of the second field is configured by a high layer signaling message; or (4) a control resource set corresponding to the second DCI signaling has an index of 0, is associated with a terminal device dedicated search space or a type 3 common search space, or is configured to follow the one or more beam states or the effective/selected beam state(s) (e.g., in the pool of beam states).

In some embodiments, the candidate values of the second field are configured by a high layer signaling message. In some embodiments, the second field indicates whether multiple beam states in the pool of beam states (e.g., in the selected beam state(s)) are applied to respective Demodulation Reference Signal (DMRS) ports or a DMRS port of the transmission.

In some embodiments, a second field associated with the indication of the beam state is absent in the second DCI message, and (1) all beam states in the pool of beam states (e.g., in the selected beam state(s)) are applied to the transmission, or (2) a subset of beam states in the pool of beam states (e.g., in the selected beam state(s)) is applied to the transmission (e.g., the specific beam is applied to the transmission).

In some embodiments, the second DCI message comprises a format that is at least one of a DCI format 1_1 or a DCI format 1_2.

In some embodiments, the transmission is related to a Channel State Information (CSI) Reference Signal (RS), the second DCI message indicates an association between the one or more beam states from the effective pool of beam states (e.g., from selected beam state(s)) and the CSI-RS. In some embodiments, the second field or a third field associated with a Sounding Reference Signal (SRS) resource set indicator in the second DCI message indicates the association.

In some embodiments, the transmission is related to a Channel State Information (CSI) Reference Signal (RS). The association between the one or more beam states and the CSI-RS is configured for a CSI-RS resource, for a CSI-RS resource set, for a CSI-RS resource setting, for a CSI report configuration, for a triggering state, for a CORESET or for a searching space set.

In some embodiments, the second DCI message comprising a format that is at least one of a DCI format 0_0, a DCI format 0_1, or a DCI format 0_2.

In some embodiments, a time-domain parameter for a periodic or semi-persistent CSI-RS is associated with the beam state. In some embodiments, the time domain parameter comprises at least one of time domain offset.

In some embodiments, the determining of the one or more beam states is based on an association parameter that is carried in a DCI message or associated with control resource set (CORESET) corresponding to a DCI message. In some embodiments, the one or more beam states from the pool of beam states (e.g., from the selected beam state(s)) are determined based on a time unit of the transmission or the DCI message, a beam state of indicated beam codepoint is applied to a transmission associated with the same association parameter as the beam state, or the pool of beam states (e.g., from the selected beam state(s)) comprises at least one beam state that is effective for a respective association parameter. In some embodiments, the association parameter comprises is indicated by a control resource set pool identifier.

In some embodiments, the second DCI message comprising a DCI format 1_0. In some embodiments, (1) the selected beam states are applied to the transmission, or (2) the specific beam state is applied to the transmission. In some embodiments, the selected beam states are applied to the transmission, and the terminal device is configured to have more than one default beam states.

In some embodiments, one or more beam states that are applied to a control resource set or a search space set for scheduling the transmission are applied to the transmission. In some embodiments, the one or more beam states associated with the control resource set are applied to the transmission in response to (1) the control resource set being associated with a single beam state, (2) a schedule offset of the transmission is greater than or equal to a threshold, (3) a QCL type (e.g., QCL Type D) or spatial relation is not applicable or configured, or (4) the transmission is in a first frequency range.

In some embodiments, more than one beam state is applied to a control resource set or a search space set configured to schedule the transmission, and wherein a specific beam state is applied to the transmission, and the specific beam state comprises at least one of: a first beam state of the more than one beam states, a first beam state in the pool of beam states (e.g., in the selected beam state(s)), or a beam state configured for the control resource set or the search space set.

In some embodiments, a specific beam state is applied to the transmission. The specific beam state comprises at least one of: a first beam state in the pool of beam state (e.g., in the selected beam state(s)), a beam state indicated by a high layer signaling message, a beam state associated with a given time unit, or a beam state associated with a control resource set.

In some embodiments, the control resource set have a specific identifier, is associated with the transmission, is monitored, or is in a latest slot of the transmission. In some embodiments, the specific beam state or all beam states in the pool of the beam states (e.g., in the selected beam state(s)) are applied to the transmission based on a capability of the terminal device or a configuration parameter. In some embodiments, a scheduling offset of the transmission is smaller than a threshold.

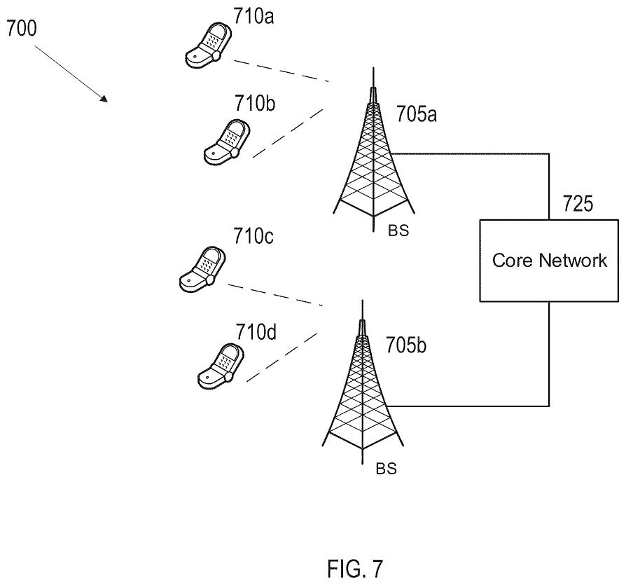

FIG. 7 shows an example of a wireless communication system 700 where techniques in accordance with one or more embodiments of the present technology can be applied. A wireless communication system 700 can include one or more base stations (BSs) 705a, 705b, one or more wireless devices (or UEs) 710a, 710b, 710c, 710d, and a core network 725. A base station 705a, 705b can provide wireless service to user devices 710a, 710b, 710c and 710d in one or more wireless sectors. In some implementations, a base station 705a, 705b includes directional antennas to produce two or more directional beams to provide wireless coverage in different sectors. The core network 725 can communicate with one or more base stations 705a, 705b. The core network 725 provides connectivity with other wireless communication systems and wired communication systems. The core network may include one or more service subscription databases to store information related to the subscribed user devices 710a, 710b, 710c, and 710d. A first base station 705a can provide wireless service based on a first radio access technology, whereas a second base station 705b can provide wireless service based on a second radio access technology. The base stations 705a and 705b may be co-located or may be separately installed in the field according to the deployment scenario. The user devices 710a, 710b, 710c, and 710d can support multiple different radio access technologies. The techniques and embodiments described in the present document may be implemented by the base stations of wireless devices described in the present document.

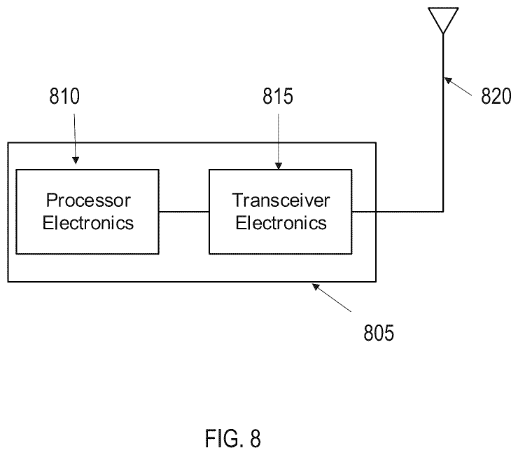

FIG. 8 is a block diagram representation of a portion of a radio station in accordance with one or more embodiments of the present technology can be applied. A radio station 805 such as a network node, a base station, or a wireless device (or a user device, UE) can include processor electronics 810 such as a microprocessor that implements one or more of the wireless techniques presented in this document. The radio station 805 can include transceiver electronics 815 to send and/or receive wireless signals over one or more communication interfaces such as antenna 820. The radio station 805 can include other communication interfaces for transmitting and receiving data. Radio station 805 can include one or more memories (not explicitly shown) configured to store information such as data and/or instructions. In some implementations, the processor electronics 810 can include at least a portion of the transceiver electronics 815. In some embodiments, at least some of the disclosed techniques, modules or functions are implemented using the radio station 805. In some embodiments, the radio station 805 may be configured to perform the methods described herein.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

1-36. (canceled)

37. A method for wireless communication, comprising:
transmitting, by a base station to a terminal device, a first signaling message configuring a plurality of transmission configuration indicator (TCI) states;
transmitting, by the base station, a second signaling message to the terminal device activating one or more TCI states that correspond to one or more TCI codepoints;
transmitting, by the base station, a first Downlink Control Information (DCI) message to the terminal device, wherein the first DCI message comprises a first field indicating a TCI codepoint of the one or more TCI codepoints corresponding to the one or more TCI states activated by the second signaling message, wherein selected TCI states are determined according to the TCI codepoint; and
transmitting, by the base station, a second DCI message to the terminal device scheduling a transmission; and
performing the transmission using a specific TCI state according to a rule, wherein the rule specifies that, upon an offset between a reception of the second DCI message and the scheduled transmission being less than a threshold, the specific TCI state is a first TCI state in the selected TCI states, and
upon the offset between the reception of the second DCI message and the scheduled transmission being equal to or greater than the threshold, the specific TCI state is indicated by a second field of the second DCI message.

38. The method of claim 37, wherein candidate values of the second field comprise at least one of a first value corresponding to having a first TCI state for the transmission, a second value corresponding to having a second TCI state for the transmission, or a third value corresponding to having both the first TCI state and the second TCI state for the transmission.

39. The method of claim 38, wherein the third value is associated with a coherent joint transmission mode in which the first and second TCI states are applied to a Demodulation Reference Signal (DMRS) port of the transmission.

40. The method of claim 37, wherein whether the second field is present in the second DCI message is configured by a high layer signaling message.

41. The method of claim 37, wherein the second DCI message comprises a format that is at least one of a DCI format 1_1 or a DCI format 1_2.

42. A method for wireless communication, comprising:
receiving, by a terminal device from a base station, a first signaling message configuring a plurality of transmission configuration indicator (TCI) states;
receiving, by the terminal device, a second signaling message from the base station activating one or more TCI states that correspond to one or more TCI codepoints;
receiving, by the terminal device, a first Downlink Control Information (DCI) message from the base station, wherein the first DCI message comprises a first field indicating a TCI codepoint of the one or more TCI codepoints corresponding to the one or more TCI states activated by the second signaling message, wherein selected TCI states are determined according to the TCI codepoint; and
receiving, by the terminal device, a second DCI message from the base station scheduling a transmission; and
performing the transmission using a specific TCI state according to a rule,
wherein the rule specifies that, upon an offset between a reception of the second DCI message and the scheduled transmission being less than a threshold, the specific TCI state is a first TCI state in the selected TCI states, and
upon the offset between the reception of the second DCI message and the scheduled transmission being equal to or greater than the threshold, the specific TCI state is indicated by a second field of the second DCI message.

43. The method of claim 42, wherein candidate values of the second field comprise at least one of a first value corresponding to having a first TCI state for the transmission, a second value corresponding to having a second TCI state for the transmission, or a third value corresponding to having both the first TCI state and the second TCI state for the transmission.

44. The method of claim 43, wherein the third value is associated with a coherent joint transmission mode and/or a second mode in which the first and second TCI states are applied to a Demodulation Reference Signal (DMRS) port of the transmission.

45. The method of claim 42, wherein whether the second field is present in the second DCI message is configured by a high layer signaling message.

46. The method of claim 42, wherein the second DCI message comprises a format that is at least one of a DCI format 1_1 or a DCI format 1_2.

47. A communication apparatus, comprising at least one processor configured to:
transmit a first signaling message to a terminal device configuring a plurality of transmission configuration indicator (TCI) states;
transmit a second signaling message to the terminal device activating one or more TCI states that correspond to one or more TCI codepoints;
transmit a first Downlink Control Information (DCI) message to the terminal device, wherein the first DCI message comprises a first field indicating a TCI codepoint of the one or more TCI codepoints corresponding to the one or more TCI states activated by the second signaling message, wherein selected TCI states are determined according to the TCI codepoint; and
transmit a second DCI message to the terminal device scheduling a transmission; and
performing the transmission using a specific TCI state according to a rule,
wherein the rule specifies that, upon an offset between a reception of the second DCI message and the scheduled transmission being less than a threshold, the specific TCI state is a first TCI state in the selected TCI states, and
upon the offset between the reception of the second DCI message and the scheduled transmission being equal to or greater than the threshold, the specific TCI state is indicated by a second field of the second DCI message.

48. The communication apparatus of claim 47, wherein candidate values of the second field comprise at least one of a first value corresponding to having a first TCI state for the transmission, a second value corresponding to having a second TCI state for the transmission, or a third value corresponding to having both the first TCI state and the second TCI state for the transmission.

49. The communication apparatus of claim 48, wherein the third value is associated with a coherent joint transmission mode and/or a second mode in which the first and second TCI states are applied to a Demodulation Reference Signal (DMRS) port of the transmission.

50. The communication apparatus of claim 47, wherein whether the second field is present in the second DCI message is configured by a high layer signaling message.

51. The communication apparatus of claim 47, wherein the second DCI message comprises a format that is at least one of a DCI format 1_1 or a DCI format 1_2.

52. A communication apparatus, comprising at least one processor configured to:
receive a first signaling message from a base station configuring a plurality of transmission configuration indicator (TCI) states;
receive a second signaling message from the base station activating one or more TCI states that correspond to one or more TCI codepoints;
receive a first Downlink Control Information (DCI) message from the base station, wherein the first DCI message comprises a first field indicating a TCI codepoint of the one or more TCI codepoints corresponding to the one or more TCI states activated by the second signaling message, wherein selected TCI states are determined according to the TCI codepoint; and
receive a second DCI message from the base station scheduling a transmission; and
perform the transmission using a specific TCI state according to a rule,
wherein the rule specifies that, upon an offset between a reception of the second DCI message and the scheduled transmission being less than a threshold, the specific TCI state is a first TCI state in the selected TCI states, and
upon the offset between the reception of the second DCI message and the scheduled transmission being equal to or greater than the threshold, the specific TCI state is indicated by a second field of the second DCI message.

53. The communication apparatus of claim 52, wherein candidate values of the second field comprise at least one of a first value corresponding to having a first TCI state for the transmission, a second value corresponding to having a second TCI state for the transmission, or a third value corresponding to having both the first TCI state and the second TCI state for the transmission.

54. The communication apparatus of claim 53, wherein the third value is associated with a coherent joint transmission mode and/or a second mode in which the first and second TCI states are applied to a Demodulation Reference Signal (DMRS) port of the transmission.

55. The communication apparatus of claim 52, wherein whether the second field is present in the second DCI message is configured by a high layer signaling message.

56. The communication apparatus of claim 52, wherein the second DCI message comprises a format that is at least one of a DCI format 1_1 or a DCI format 1_2.
